(19) United States
(12) Patent Application Publication
(10) Pub. No.: US 2005/0221132 A1
(43) Pub. Date: Oct. 6, 2005

(54) Rubber composition for fuel reforming system and rubber hose for fuel reforming system using the rubber composition

(75) Inventors: Ryo Hirai, Komaki-shi (JP); Ayumu Ikemoto, Komaki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOKAI RUBBER INDUSTRIES, LTD., Komaki-shi (JP)

(21) Appl. No.: 11/087,623

(22) Filed: Mar. 24, 2005

(30) Foreign Application Priority Data
Mar. 26, 2004 (JP) JP2004-092456

(51) Int. Cl. H01M 8/00

(52) U.S. Cl. 429/12

(57) ABSTRACT

A rubber composition that is used for a fuel reforming system and has high resistance to fossil fuel and low extractability, as well as excellent extrusion moldability is provided. A rubber hose for the fuel reforming system using the rubber composition is also provided. The rubber composition for a fuel reforming system includes the following components (A), (B), and (C): (A) a fluorocarbon rubber;
(B) carbon black having a specific surface area less than 28 m²/g as determined by a BET method; and (C) a non-sulfur-based cross-linker. The rubber hose for a fuel reforming system is made of the rubber composition.

### BACKGROUND OF THE INVENTION

1. Field of the Invention

The present invention relates to a rubber composition for a fuel reforming system and a rubber hose that is used for the fuel reforming system and is made of the rubber composition.

2. Description of the Related Art

A fuel-cell system is regarded as a promising next-generation power generation system. The energy generated by the fuel-cell system can be very efficiently utilized, for example, for a power source for automobiles and domestic electricity and hot water. The fuel-cell system consumes hydrogen to generate electricity. This hydrogen may be produced by reforming fossil fuel (mainly, kerosene and gasoline). FIG. 1 shows a system (a fuel reforming system) for reforming the fossil fuel into hydrogen. A fossil fuel tank (a kerosene tank) 11 and a desulfurizer 12 are connected through a tube 14, and the desulfurizer 12 and a reformer 13 are connected through a tube 15. The kerosene in the fossil fuel tank 11 passes through the tube 14 and is refined into a low-sulfur kerosene through the desulfurizer 12. Then, the low-sulfur kerosene passes through the tube 15 and is reformed into hydrogen through the reformer 13. The hydrogen thus produced is supplied to a system that requires hydrogen, for example, the fuel-cell system described above.

In the fuel reforming system, the tubes 14 and 15 are usually made of a metal like SUS. However, since the metal tube is rigid, it is difficult to assemble the metal tubes. Furthermore, the metal tube may suffer from metal fatigue or corrosion during long-term service. To solve such problems, a tube that is made of an elastomer material (a rubber-elastic material) and can be used as the tubes 14 and 15 for the fuel reforming system has been desired. However, the elastomer material often contains sulfur or a metal element If such a component is extracted into a fuel to be reformed (a fuel in the hose), the component poisons a catalyst (a reforming catalyst, a water-gas shift agent, a catalyst for removing carbon monoxide, or other catalysts), such as platinum used in the fuel reforming system, and thereby significantly deteriorates the performance of the catalyst. To prevent this catalytic poisoning, a material used in the hose (in particular, the tube 15 between the desulfurizer 12 and the reformer 13) should be an elastomer material free of such elements. Japanese Unexamined Patent Application Publication No. 2003-201401 has recently proposed a fluorocarbon rubber (FKM) hose that is cross-linked using a non-sulfur cross-linker and has an excellent resistance to the fossil fuel (oil resistance).

However, a fluorocarbon rubber has poor extrusion moldability (fluidity) and is unsuited to extrude a hose without any modification. Thus, a processing aid, such as a candelilla wax, is commonly added to the fluorocarbon rubber to modify the extrusion moldability. However, the processing aid is not involved in the crosslinking of the rubber and is therefore hardly stabilized in the rubber compound. As a result, the processing aid tends to elute into the fossil fuel to be reformed. The processing aid eluted from the rubber compound may adversely affect the reforming system. Thus, there is a need for a rubber composition that has excellent extrusion moldability without the processing aid.

### SUMMARY OF THE INVENTION

In view of such circumstances, it is an object of the present invention to provide a rubber composition that is used for a fuel reforming system and has high resistance to fossil fuel and low extractability, as well as excellent extrusion moldability. It is another object of the present invention to provide a rubber hose that can be used for the fuel reforming system and is made of the rubber composition.

To this end, one aspect of the present invention is a rubber composition for a fuel reforming system, comprising:
(A) a fluorocarbon rubber;
(B) carbon black having a specific surface area less than 28 m²/g as determined by a BET method; and
(C) a non-sulfur-based cross-linker.

Another aspect of the present invention is a rubber hose that is used for a fuel reforming system and is made of the rubber composition for a fuel reforming system.

The present inventors have intensively studied a rubber composition for a fuel reforming system to solve the problems described above. As a result, the present inventors had the idea of adding reinforcing carbon black to the fluorocarbon rubber to improve the extrusion moldability (fluidity). However, because the carbon black usually contains sulfur, the use of the carbon black in the rubber composition for a fuel reforming system may cause a problem. Considering this fact, the present inventors made a further investigation and found that the use of the carbon black having a specific surface area (as determined by a BET method) less than 28 m²/g can solve the problems including the sulfur extraction, and thereby accomplished the present invention.

The rubber composition for a fuel reforming system according to the present invention is based on a fluorocarbon rubber and contains a specific carbon black. This eliminates the adverse effect of the sulfur extraction on the fuel reforming system and improves the extrusion moldability. Furthermore, depending on the characteristics of the fluorocarbon rubber, the rubber composition may have higher resistance to the fossil fuel. When a hose for a fuel reforming system is made of the rubber composition, the hose has a high mechanical strength and is easily assembled. In addition, similar to the characteristics of the rubber composition, the rubber hose has high resistance to the fossil fuel and low extractability, thus serving an excellent function in the fuel reforming system.

In particular, when the specific carbon black described above has a light transmittance of a toluene extract (LT) of at least 40%, the rubber hose has a higher mechanical strength while keeping the low extractability.

Furthermore, the fluorocarbon rubber containing at least 66% by weight of fluorine exhibits higher resistance to the fossil fuel.

Furthermore, the fluorocarbon rubber having a molecular weight distribution (Mw/Mn) in the range of 2 to 40 has more excellent extrusion moldability.

Furthermore, the fluorocarbon rubber having a number-average molecular weight (Mn) of at least 100,000 has a sufficient mechanical strength.

Furthermore, when the rubber composition for a fuel reforming system contains a polyol cross-linker and/or a peroxide cross-linker, the rubber composition exhibits higher sealing performance.

The rubber composition for a fuel reforming system according to the present invention can be used not only as a hose material for fuel-cell electric vehicles and a hose for stationary fuel-cells, but also as other components constituting the fuel reforming system (such as, an O-ring, a diaphragm, a packing, or a gasket). Furthermore, the rubber composition can also be used as a kerosene hose.

### BRIEF DESCRIPTION OF THE DRAWINGS

FIG. 1 is a block diagram of a fuel reforming system.

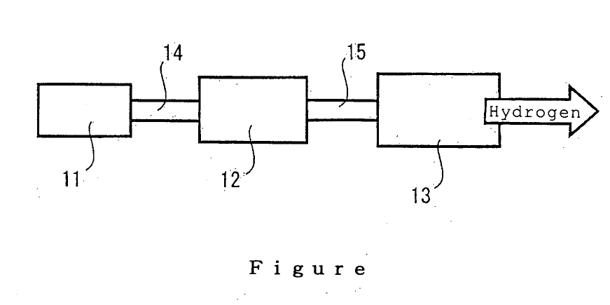

### DESCRIPTION OF THE PREFERRED EMBODIMENTS

Embodiments of the present invention will be described in detail below.

The rubber composition for a fuel reforming system according to the present invention can be prepared using a fluorocarbon rubber (A component), a specific carbon black (B component), and a non-sulfur-based cross-linker (C component).

Examples of the fluorocarbon rubber (A component) include, but are not limited to, a vinylidene fluoride-propylene hexafluoride copolymer, a vinylidene fluoride-propylene hexafluoride-ethylene tetrafluoride terpolymer, an ethylene tetrafluoride-propylene copolymer, an ethylene tetrafluoride-perfluorovinyl ether copolymer, and a vinylidene fluoride-ethylene tetrafluoride-perfluoroalkyl vinyl ether terpolymer. These are used alone or in combination. Among them, a vinylidene fluoride-propylene hexafluoride-ethylene tetrafluoride terpolymer is preferred because of its high resistance to the fossil fuel and high heat resistance.

The fluorine content of the fluorocarbon rubber (A component) is preferably at least 66% by weight and is more preferably 68 to 72% by weight. That is, when the fluorine content is less than 66% by weight, sufficient resistance to the fossil fuel (oil resistance) can be hardly achieved.

Furthermore, the fluorocarbon rubber (A component) having a molecular weight distribution (Mw/Mn) in the range of 2 to 40 has better extrusion moldability. That is, when the molecular weight distribution is less than 2, the surface texture of an extrudate tends to be rough. By contrast, when the molecular weight distribution exceeds 40, the extrusion moldability (fluidity) tends to be deteriorated. The term “Mw/Mn” used herein refers to the ratio of a weight-average molecular weight (Mw) to a number-average molecular weight (Mn), as determined by gel permeation chromatography (GPC).

Furthermore, the fluorocarbon rubber (A component) having a number-average molecular weight (Mn) of at least 100,000 has a sufficient mechanical strength. That is, when the number-average molecular weight (Mn) is less than 100,000, the rubber product, such as a hose, cannot have a sufficient mechanical strength.

As described above, the carbon black (B component) used in combination with the fluorocarbon rubber (A component) has a specific surface area of less than 28 m²/g as determined by the BET method. Preferred examples of such a carbon black include an FT (Fine Thermal) carbon black, an SRF (Semi Reinforcing Furnace) carbon black, and an MT (Medium Thermal) carbon black Preferably, the specific surface area (as determined by the BET method) is less than 20 m²/g. Examples of the carbon black having such a specific surface area include the SRF carbon black and the MT carbon black. That is, when the specific surface area (as determined by the BET method) is 28 m²/g or more, a large amount of sulfur is eluted from the carbon black, and thus the carbon black no longer serves as a low sulfur material. According to the BET method, an inert gas, such as nitrogen, is adsorbed on a powder sample (carbon black) to obtain an adsorption isotherm, from which the amount of gas necessary to form a monomolecular adsorption layer on the surface of the powder sample can be calculated. Then, on the basis of the dimensions of the adsorbed gas molecule, the surface area of the powder sample can be calculated. The specific surface area of the powder sample can be calculated from a monolayer adsorption Vₘ, a constant C, and an occupied area of the admolecule according to the following equation (1):
P/V(P₀−P)=1/VₘC+P(C−1)/P⁰VₘC (1)
wherein, V denotes the amount of the adsorbed inert gas at a pressure P, and P₀ denotes the saturated vapor pressure of the inert gas.

Furthermore, the specific carbon black (B component) preferably has a light transmittance of a toluene extract (LT) of at least 40%. That is, when the light transmittance of a toluene extract (LT) is less than 40%, an unburned content in the carbon black increases, and thereby the low extractability may be deteriorated. The light transmittance of a toluene extract (LT) can be determined according to Japanese Industrial Standards (hereinafter just abbreviated to “JIS”) K 6218.

The content of the carbon black (B component) is preferably in the range of 1 to 60 parts by weight (herein referred to only as “parts”) based on 100 parts of the fluorocarbon rubber (A component) and is more preferably in the range of 5 to 30 parts. That is, when the carbon black content is less than 1 part, the improvement effect on the extrusion moldability and the reinforcing effect are insufficient. By contrast, when the carbon black content exceeds 60 parts, the rubber product, such as a hose, tends to have little flexibility.

Examples of the non-sulfur-based cross-linker (C component) used in combination with the R component and the B component include, but are not limited to, a polyol cross-linker, a peroxide cross-linker, and a polyamine cross-linker. Among them, the polyol cross-linker and the peroxide cross-linker are preferred because of their excellent sealing performance. The combination of the polyol cross-linker and the peroxide cross-linker is more preferred because the sealing performance further increases.

Examples of the polyol cross-linker include alkylene glycols, such as ethylene glycol, propylene glycol, 1,3-propanediol, 1,4-butanediol, 1,5-pentanediol, neopentyl glycol, 1,6-hexanediol, 2-methyl-1,3-propanediol, 3-methyl-1,5-pentanediol, 2-methyl-1,5-pentanediol, 2,2-diethyl-1,3-propanediol, 2-butyl-2-ethyl-1,3-propanediol, 1,9-nonanediol, and 1,10-decanediol; alicyclic glycols, such as, 1,4-cyclohexane dimethanol, 1,3-cyclohexane dimethanol, 1,2-cyclohexane dimethanol, and TCD glycol; diethylene glycol, dimer diol, an alkylene oxide adduct of bisphenol A, an alkylene oxide adduct of bisphenol F, and a fluorine-containing aliphatic diol. These are used alone or in combination.

Examples of the peroxide cross-linker include peroxyketals, such as, 1,1-bis(t-butylperoxy)-3,3,5-trimethylcyclohexane, 1,1-bis(t-hexylperoxy)-3,3,5-trimethylcyclohexane, 1,1-bis(t-hexylperoxy)cyclohexane, 1,1-bis(t-butylperoxy)cyclododecane, 1,1-bis(t-butylperoxy)cyclohexane, 2,2-bis(t-butylperoxy)octane, n-butyl-4,4-bis(t-butylperoxy)butane, and n-butyl-4,4-bis(t-butylperoxy)valerate; dialkyl peroxides, such as di-t-butyl peroxide, dicumyl peroxide, t-butyl cumyl peroxide, α,α′-bis(t-butylperoxy-m-isopropyl)benzene, α,α′-bis(t-butylperoxy)diisopropylbenzene, 2,5-dimethyl-2,5-di(t-butylperoxy)hexane, and 2,5-dimethyl-2,5-bis (t-butylperoxy)hexyne-3; diacyl peroxides, such as acetyl peroxide, isobutyryl peroxide, octanoyl peroxide, decanoyl peroxide, lauroyl peroxide, 3,5,5-trimethyl hexanoyl peroxide, benzoyl peroxide, 2,4-dichlorobenzoyl peroxide, and m-toluoyl peroxide; peroxyesters, such as t-butyl peroxyacetate, t-butyl peroxyisophtalate, t-butyl peroxy-2-ethylhexanoate, t-butyl peroxylaurate, t-butyl peroxybenzoate, di-t-butyl peroxyisophthalate, 2,5-dimethyl-2,5-di(benzoylperoxy)hexane, t-butyl peroxymaleic acid, t-butyl peroxyisopropylcarbonate, and cumyl peroxyoctate; and hydroperoxides, such as t-butyl hydroperoxide, cumene hydroperoxide, diisopropylbenzene hydroperoxide, 2,5-dimethylhexane-2,5-dihydroperoxide, and 1,1,3,3 -tetramethylbutyl hydroperoxide. These are used alone or in combination.

Preferably, the content of the non-sulfur-based cross-linker (C component) is in the range of 0.1 to 20 parts per 100 parts of the fluorocarbon rubber (A component). That is, when the cross-linker content is less than 0.1 part, the crosslinking may be insufficient, and thus the strength of the rubber product may be decreased. By contrast, when the cross-linker content exceeds 20 parts, the rubber product tends to be too rigid and have little flexibility.

The rubber composition for a fuel reforming system according to the present invention may contain a vulcanization accelerator as required, in addition to the components (A), (B), and (C). Preferred examples of the vulcanization accelerator include quaternary ammonium compounds (such as methyl trioctyl ammonium chloride, benzyl triethyl ammonium chloride, tetrahexylammonium tetrafloroborate, and 8-methyl-1,8-diaza-bicyclo[5.4.0]-7-undecenium chloride), and quaternary phosphonium compounds (such as, benzyl triphenyl phosphonium chloride, m-trifluoromethyl methylbenzyl trioctyl phosphonium chloride, and benzyl trioctyl phosphonium bromide).

The rubber composition for a fuel reforming system according to the present invention may contain a metal oxide, such as magnesium oxide or calcium oxide, and a metal hydroxide, such as calcium hydroxide, as required, in addition to the components described above. Furthermore, in addition to these components, the rubber composition for a fuel reforming system according to the present invention, if necessary, may contain a co-crosslinker, a reinforcing agent, a white filler, a plasticizer, a processing aid, an antioxidant, and a flame retardant, as long as they do not deteriorate the characteristics that the present invention concerns, such as the low extractability.

The rubber hose for a fuel reforming system according to the present invention may be manufactured in the following manner. First, component materials (A), (B), and (C), and, if necessary, other component materials are prepared. Second, these component materials are mixed in a mixer, such as a rolling mill, a kneader, a Banbury mixer, or a twin-screw extruder to produce a rubber composition (a rubber composition for a fuel reforming system). Third, the rubber composition is extruded with an extruder into a monolayer rubber hose for a fuel reforming system. The rubber hose may be laminated to another rubber material to form a multilayer hose, if necessary.

The rubber hose can be used not only in a fuel reforming system for automobile fuel-cells or household fuel-cells, but also in any fuel reforming system. Furthermore, the rubber hose can also be suitably used as a kerosene hose. In addition, the rubber composition for a fuel reforming system according to the present invention can not only be used in a rubber hose for the fuel reforming system as described above, but also be molded into an O-ring, a diaphragm, a packing, or a gasket for the fuel reforming system by changing the shape as appropriate.

Examples of the present invention will be described below in conjunction with comparative examples.

The following materials were used in the examples and comparative examples.

Fluorocarbon Rubber (i) (A Component)

A fluorocarbon rubber [fluorine content: 69% by weight, Mn: 350,000, (Mw/Mn): 12]

Fluorocarbon Rubber (ii) (A Component)

A fluorocarbon rubber [fluorine content: 69% by weight, Mn: 580,000, (Mw/Mn): 1]

Fluorocarbon Rubber (iii) (A Component)

A fluorocarbon rubber [fluorine content: 69% by weight, Mn: 410,000, (Mw/Mn): 2]

Fluorocarbon Rubber (iv) (A Component)

A fluorocarbon rubber [fluorine content: 69% by weight, Mn: 350,000, (Mw/Mn): 30]

Fluorocarbon Rubber (v) (A Component)

A fluorocarbon rubber [fluorine content: 69% by weight, Mn: 200,000, (Mw/Mn): 50]

Fluorocarbon Rubber (vi) (A Component)

A fluorocarbon rubber [fluorine content: 64% by weight, Mn: 400,000, (Mw/Mn): 15]

Fluorocarbon Rubber (vii) (A Component)

A fluorocarbon rubber [fluorine content: 69% by weight, Mn: 100,000, (Mw/Mn): 15]

Fluorocarbon Rubber (i) (A Component)

MT N990 (trade name) [specific surface area (BET): 8 m²/g, light transmittance of a toluene extract (LT): 83%], Degussa

Carbon Black (ii)

Diablack G (trade name) [specific surface area (BET): 32 m²/g, light transmittance of a toluene extract (LT): 78%], Mitsubishi Chemical Corporation

Carbon Black (iii)

Diablack (trade name) [specific surface area (BET): 32 m²/g, light transmittance of a toluene extract (LT): 30%], Mitsubishi Chemical Corporation

Calcium Hydroxide

Magnesium Oxide

Peroxide Cross-Linker

2,5-dimethyl-2,5-di(t-butylperoxyl)hexane, NOF Corporation
   Polyol Cross-Linker

Bisphenol AF, Wako Pure Chemical Industries, Ltd.

### EXAMPLES 1 TO 8, COMPARATIVE EXAMPLES 1 AND 2

Rubber compositions for a fuel reforming system were prepared by compounding the components shown in Tables 1 and 2 in a kneader and a rolling mill.

TABLE 1

| | Examples | | | | | |
|---|---|---|---|---|---|---|
| | 1 | 2 | 3 | 4 | 5 | 6 |
| Fluorocarbon | 100 | 100 | — | — | — | — |
| rubber (i) | | | | | | |
| Fluorocarbon | — | — | 100 | — | — | — |
| rubber (ii) | | | | | | |
| Fluorocarbon | — | — | — | 100 | — | — |
| rubber (iii) | | | | | | |
| Fluorocarbon | — | — | — | — | 100 | |
| rubber (iv) | | | | | | |
| Fluorocarbon | — | — | — | — | — | 100 |
| rubber (v) | | | | | | |
| Fluorocarbon | — | — | — | — | — | — |
| rubber (vi) | | | | | | |
| Fluorocarbon | — | — | — | — | — | — |
| rubber (vii) | | | | | | |
| Carbon black | 15 | 15 | 15 | 15 | 15 | 15 |
| (i) | | | | | | |
| Carbon black | — | — | — | — | — | — |
| (ii) | | | | | | |
| Carbon black | — | — | — | — | — | — |
| (iii) | | | | | | |
| Calcium | 3 | 3 | 3 | 3 | 3 | 3 |
| hydroxide | | | | | | |
| Magnesium | 6 | 6 | 6 | 6 | 6 | 6 |
| oxide | | | | | | |
| Peroxide | — | 1 | — | — | — | — |
| cross-linker | | | | | | |
| Polyol | 2 | 2 | 2 | 2 | 2 | 2 |
| cross-linker | | | | | | |

TABLE 2

| | |
|---|---|
| | Comparative |
| Examples | examples |

| | 7 | 8 | 1 | 2 |
|---|---|---|---|---|
| Fluorocarbon | — | — | 100 | 100 |
| rubber (i) | | | | |
| Fluorocarbon | — | — | — | — |
| rubber (ii) | | | | |
| Fluorocarbon | — | — | — | — |
| rubber (iii) | | | | |
| Fluorocarbon | — | — | — | — |
| rubber (iv) | | | | |
| Fluorocarbon | — | — | — | — |
| rubber (v) | | | | |
| Fluorocarbon | 100 | — | — | — |
| rubber (vi) | | | | |
| Fluorocarbon | — | 100 | — | — |
| rubber (vii) | | | | |
| Carbon black | 15 | 15 | — | — |
| (i) | | | | |
| Carbon black | — | — | 15 | — |
| (ii) | | | | |
| Carbon black | — | — | — | 15 |
| (iii) | | | | |
| Calcium | 3 | 3 | 3 | 3 |
| hydroxide | | | | |
| Magnesium | 6 | 6 | 6 | 6 |
| oxide | | | | |
| Peroxide | — | — | — | — |
| cross-linker | | | | |
| Polyol | 2 | 2 | 2 | 2 |
| cross-linker | | | | |

The resulting rubber compositions were extruded over a mandrel and were heated at 160° C. for 1 hour to produce a monolayer rubber hose for a fuel reforming system (the thickness of the layer: 2 mm, the inside diameter of the hose; 20 mm).

The resulting rubber compositions for a fuel reforming system and rubber hoses in the examples and the comparative examples were evaluated for the following characteristics according to the standard described below. These results were shown in Tables 3 and 4.

### Impermeability to Fossil Fuel

Each rubber hose was attached to a bulge-shaped aluminum casting pipe having a straight diameter of 31 mm in accordance with JASO M101. Then, the rubber hose was fastened with a worm gear clamp in accordance with JASO F207 at a tightening torque of 3 N·m. Then, kerosene was fed through the hose for 500 hours. The bleeding of the kerosene on the outer surface of the rubber hose was visually inspected. When no bleeding of the kerosene was observed, the impermeability of the rubber hose to the kerosene was regarded as excellent. When the bleeding of the kerosene was observed but no practical problem was expected, it was regarded as fair.

Surface Texture of Extrudate

The surface texture of an extrudate produced by extruding the rubber composition using a Garvey die was visually inspected. The surface texture was represented by excellent and fair in the order of smoothness.

Extrusion Moldability (Fluidity)

The adhesion level of the rubber composition on a screw in an extruder after the extrusion of the rubber composition was visually inspected to evaluate the fluidity (extrusion moldability) of the rubber composition. That is, when no adhesion of the rubber composition was observed on the screw in the extruder, the extrusion moldability (fluidity) of the rubber composition was regarded as excellent. When some adhesion of the rubber composition was observed, it was regarded as fair.

Mechanical Strength

Each rubber composition was pressed and was cross-linked at 160° C. for 45 minutes into a cross-linked rubber sheet having a thickness of 2 mm. Then, a JIS No. 5 dumbbell specimen was punched out, and the mechanical strength [the tensile strength at break (TB) and the elongation at break (EB)] of the specimen was measured according to JIS K 6251. The specimen having a tensile strength at break (TB) of at least 9.8 MPa was regarded as excellent. The specimen having a tensile strength at break (TB) of at least 4.9 MPa but less than 9.8 MPa was regarded as fair. The specimen having a tensile strength at break (TB) less than 4.9 MPa was regarded as poor. The specimen having an elongation at break (EB) of at least 100% was regarded as excellent. The specimen having an elongation at break (EB) less than 100% was regarded as poor.

Sulfur Extractivity

A piece of cross-linked rubber sample (2.8 cm×2.8 cm×2.0 mm in thickness) prepared as with the cross-linked rubber sheet described above was dipped in 50 ml of kerosene (sulfur content 30 ppm). After the reflux at 80° C. for 168 hours, the sample was removed to a predetermined container. Then, the sulfur content in the kerosene was determined according to ASTM D 5453. When the sulfur content did not increase relative to the sulfur content in the kerosene before the immersion of the sample, the sulfur extractivity of the sample was regarded as excellent. By contrast, when the sulfur content increased after the immersion of the sample, the sulfur extractivity of the sample was regarded as poor.

Volume Resistivity

The volume resistivity of each rubber composition was determined according to JIS K 6911. The rubber composition having a volume resistivity of at least 1.0×10⁵ Ω·cm was regarded as excellent.

TABLE 3

| | Examples | | | | | |
|---|---|---|---|---|---|---|
| | 1 | 2 | 3 | 4 | 5 | 6 |
| Impermeability | Excellent | Excellent | Excellent | Excellent | Excellent | Excellent |
| to fossil fuel | | | | | | |
| Surface | Excellent | Excellent | Fair | Excellent | Excellent | Excellent |
| texture of | | | | | | |
| extrudate | | | | | | |
| Extrusion | Excellent | Excellent | Excellent | Excellent | Excellent | Fair |
| moldability | | | | | | |
| Tensile | Excellent | Excellent | Excellent | Excellent | Excellent | Excellent |
| strength | | | | | | |
| Elongation | Excellent | Excellent | Excellent | Excellent | Excellent | Excellent |
| Sulfur | Excellent | Excellent | Excellent | Excellent | Excellent | Excellent |
| extractivity | | | | | | |
| Volume | Excellent | Excellent | Excellent | Excellent | Excellent | Excellent |
| resistivity | | | | | | |

TABLE 4

| | | | Comparative | |
|---|---|---|---|---|
| | Examples | | examples | |
| | 7 | 8 | 1 | 2 |
| Impermeability | Fair | Excellent | Excellent | Excellent |
| to fossil fuel | | | | |
| Surface texture | Excellent | Excellent | Excellent | Excellent |
| of extrudate | | | | |
| Extrusion | Excellent | Excellent | Excellent | Excellent |
| moldability | | | | |
| Tensile strength | Excellent | Fair | Excellent | Poor |
| Elongation | Excellent | Excellent | Excellent | Poor |
| Sulfur | Excellent | Excellent | Poor | Poor |
| extractivity | | | | |
| Volume | Excellent | Excellent | Excellent | Excellent |
| resistivity | | | | |

The results demonstrated that the rubber compositions or the rubber hoses in the examples had high mechanical strengths, excellent extrusion moldability, excellent impermeability to the fossil fuel, and low extractivity of sulfur or organic compounds. Thus, it is apparent that the rubber compositions and the rubber hoses according to the present invention are suitable for a fuel reforming system. In particular, the rubber hose according to Example 2, which used both the polyol cross-linking and the peroxide cross-linking, was determined to have better sealing performance.

On the other hand, in the rubber composition according to Comparative Example 1, since the carbon black had a specific surface area (BET) of at least 28 m²/g, a large amount of sulfur was eluted from the carbon black. Thus, the rubber composition according to Comparative Example 1 is not suitable for a fuel reforming system. In the rubber composition according to Comparative Example 2, since the carbon black had a specific surface area (BET) of at least 28 m²/g and too low light transmittance of a toluene extract (LT), a large amount of sulfur was eluted from the carbon black. Thus, the rubber composition according to Comparative Example 2 is not suitable for a fuel reforming system.

1. A rubber composition for a fuel reforming system, comprising:
(A) a fluorocarbon rubber;
(B) carbon black having a specific surface area less than 28 m²/g as determined by a BET method; and
(C) a non-sulfur-based cross-linker.

2. The rubber composition for a fuel reforming system according to claim 1, wherein the light transmittance of a toluene extract (LT) of the carbon black is at least 40%.

3. The rubber composition for a fuel reforming system according to claim 1, wherein the fluorocarbon rubber has a fluorine content of at least 66% by weight.

4. The rubber composition for a fuel reforming system according to claim 1, wherein the molecular weight distribution (Mw/Mn) of the fluorocarbon rubber is in the range of 2 to 40.

5. The rubber composition for a fuel reforming system according to claim 1, wherein the number-average molecular weight (Mn) of the fluorocarbon rubber is at least 100,000.

6. The rubber composition for a fuel reforming system according to claim 1, wherein the non-sulfur-based cross-linker is a polyol cross-linker and/or a peroxide cross-linker.

7. A rubber hose for a fuel reforming system, the rubber hose being made of the rubber composition according to claim 1.

8. A rubber hose for a fuel reforming system, the rubber hose being made of the rubber composition according to claim 2.

9. A rubber hose for a fuel reforming system, the rubber hose being made of the rubber composition according to claim 3.

10. A rubber hose for a fuel reforming system, the rubber hose being made of the rubber composition according to claim 4.

11. A rubber hose for a fuel reforming system, the rubber hose being made of the rubber composition according to claim 5.

12. A rubber hose for a fuel reforming system, the rubber hose being made of the rubber composition according to claim 6.

13. A rubber hose for a fuel reforming system, the rubber hose being made of the rubber composition according to claim 7.
